(19) United States
(12) Patent Application Publication
(10) Pub. No.: US 2013/0093378 A1
(43) Pub. Date: Apr. 18, 2013

(54) AUTOMATIC CHARGING SYSTEM FOR ELECTRIC VEHICLE

(71) Applicant: WEN-LO CHEN, Taipei City (TW)

(72) Inventor: WEN-LO CHEN, Taipei City (TW)

(21) Appl. No.: 13/275,280

(22) Filed: Oct. 17, 2011

(51) Int. Cl. H02J 7/00

(52) U.S. Cl. 320/101

(57) ABSTRACT

The automatic charging system for an electric vehicle contains a battery module, an electrolytic cell electrically and a hydrogen/oxygen fuel cell, both electrically connected to the battery module. The battery module provides electricity to the electrolytic cell where water inside is electrolyzed into hydrogen and oxygen which is delivered to the hydrogen/oxygen fuel cell through a gas pipe. The hydrogen/oxygen fuel by chemical reaction produces electricity which charges the battery module and water which is delivered to the electrolytic cell through a water pipe. The battery module provides electricity to the power system and electrical system of the electric vehicle.

### TECHNICAL FIELD OF THE INVENTION

The present invention is generally related to electric vehicles, and more particular to an automatic charging system to the battery module of an electric vehicle.

### DESCRIPTION OF THE PRIOR ART

The exhaust from conventional gasoline or diesel engines is a major cause to atmospheric pollution and global warming. The gas pollutants such as CO, SO_{X}, CO₂, HC compounds from the diesel engine's combustion process would deteriorate the ozone layer, lead to acid rain and smog, raise global temperature, and trigger many other global ecological problems. Additionally, the PAHs (polycyclic aromatic hydrocarbons) in the pollutants would also lead to pathological changes to the lung, trachea, and respiratory tract. Even though the pollution from gasoline engines is less than that of the diesel engines, the produced HC compounds and other toxicants are still harmful to human health and the environment.

The auto industry has been providing various solutions such as adding filtration system at the exhaust pipe. However, this still does not resolve the environmental problem of burning fossil fuel. There is also significant advancement in electric, hybrid, or solar-powered cars. However, the battery's capacity, charging speed, weight, etc. are major issues preventing the electric cars from cost-effective production and wide popularity. Most of all, there is significant difficulty in building charging stations. If the same density of gasoline stations is to be achieved, then more nuclear, fire, hydraulic power plants have to be built. If the electric cars are charged at households, for dense-populated countries or areas where most people live in apartments and high rise buildings, charging electric cars is not a convenient task.

### SUMMARY OF THE INVENTION

An objective of the present invention is to obviate the inconvenience and difficulty of charging electric vehicles by providing an automatic charging system.

The gist of the present invention is as follow. The automatic charging system for an electric vehicle contains a battery module, an electrolytic cell electrically and a hydrogen/oxygen fuel cell, both electrically connected to the battery module. The battery module provides electricity to the electrolytic cell where water inside is electrolyzed into hydrogen and oxygen which is delivered to the hydrogen/oxygen fuel cell through a gas pipe. The hydrogen/oxygen fuel by chemical reaction produces electricity which charges the battery module and water which is delivered to the electrolytic cell through a water pipe. The battery module provides electricity to the power system and electrical system of the electric vehicle.

As such, the water is automatically and continuously recycled to the electrolytic cell without manual refill. On the other hand, the battery module is continuously recharged so as to provide the required electricity to the power system and the electrical system of the electric vehicle. This cycle will run continuously and the electric vehicle as such is automatically charged.

A transformer is configured between the electrolytic cell and the battery module. Through the control of the electric vehicle's computer, when the electric vehicle is turned on or off, electricity is automatically provided to or disrupted from the electrolytic cell. For the former, the electrolytic cell's output voltage and current are automatically adjusted so as to control the speed of the electrolytic reaction between hydrogen and oxygen, and their amount to the hydrogen/oxygen fuel cell.

As the battery module of the electric vehicle provides the electricity required by the electrolytic cell, which in turn produces electricity to charge the battery module, this feedback mechanism help improving electricity generation efficiency.

A throttle valve is configured on the gas pipe so that, when the electric vehicle is turned off, the throttle valve automatically shuts down the provision of hydrogen and oxygen to the hydrogen/oxygen fuel cell.

A flow controller is configured on the water pipe so as to control the amount of water fed to the electrolytic cell from the hydrogen/oxygen fuel cell.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing an automatic charging system according to an embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

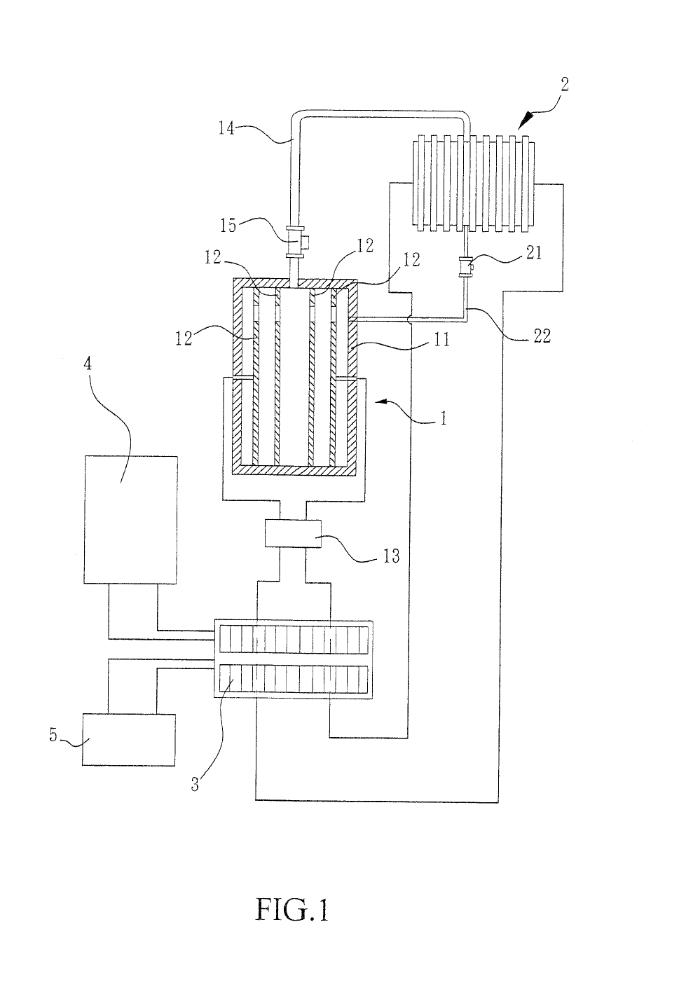

FIG. 1 is a schematic diagram showing an automatic charging system according to an embodiment of the present invention. As illustrated, the automatic charging system mainly contains an electrolytic cell 1, a hydrogen/oxygen fuel cell 2, and a battery module 3, all installed at appropriate places on an electric vehicle. Inside a chamber 11 of the electrolytic cell 1, there are a number of electrode plates 12 for conducting the electrolytic reaction. The electrolytic cell 1 is electrically connected to the battery module 3 (which is a required part of an electric vehicle) via a transformer 13. Normally, the battery voltage for an ordinary automobile is 12V, which is lowered to 6V by the transformer 13 and fed to the electrolytic cell 1 for the electrolytic reaction. According to the present invention, at least a gas pipe 14 is connected between the chamber 11 and the hydrogen/oxygen fuel cell 2. The gas pipe 14 is configured with a throttle valve 15. The hydrogen/oxygen fuel cell 2 is electrically connected to the battery module 3 and a water pipe 22 is connected to the electrolytic cell 1. The water pipe 22 is configured with a flow controller 21 so as to control the amount of water flowing from the hydrogen/oxygen fuel cell 2 to the electrolytic cell 1. The battery module 3 is electrically connected to the power system 4 (e.g., motor) and the electrical system 5 (for powering lighting, audio, etc. devices) of the electric vehicle. When the electrical vehicle is turned off, the throttle valve 15 is automatically shut down to stop the output from the hydrogen/oxygen fuel.

The automatic charging system is controlled by the electric vehicle's computer. When the electric vehicle is turned on or off, electricity is automatically provided to or disrupted from the electrolytic cell 1. For the former, the electrolytic cell 1's output voltage and current are automatically adjusted so as to control the speed of the electrolytic reaction between hydrogen and oxygen. When there is not enough water, an alarm is issued and the provision of electricity is shut down. When water is sufficient, the provision of electricity is automatically restored. When water is electrolyzed in the electrolytic cell 1, the speed of production of hydrogen and oxygen is controlled steadily by the applied voltage and current. The produced hydrogen and oxygen is then continuously fed to the hydrogen/oxygen fuel cell 2 through the gas pipe 14 under negative pressure (siphon effect) for conducting chemical reaction and producing electricity. The produced electricity is stored in the battery module 3 whereas the water produced by the hydrogen/oxygen fuel cell 2 is recycled to the electrolytic cell 1 through the water pipe 22. The amount of water entering the electrolytic cell 1 is controlled by the flow controller 22. In other words, the electrolytic cell 1 is automatically filled with water, thereby saving the trouble of manual refill. On the other hand, the battery module 3 is continuously recharged so as to provide the required electricity to the power system 4 and the electrical system 5.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An automatic charging system for an electric vehicle, comprising:
a battery module of said electric vehicle;
an electrolytic cell electrically connected to said battery module;
a hydrogen/oxygen fuel cell electrically connected to said battery module, and connected to said electrolytic cell through at least a gas pipe and a water pipe; and
a power system of said electric vehicle electrically connected to said battery module;
wherein said battery module provides electricity to said electrolytic cell where water inside is electrolyzed into hydrogen and oxygen which is delivered to said hydrogen/oxygen fuel cell through said gas pipe; said hydrogen/oxygen fuel by chemical reaction produces electricity which charges said battery module and water which is delivered to said electrolytic cell through said water pipe; and said battery module provides electricity to said power system of said electric vehicle.

2. The automatic charging system according to claim 1, wherein said battery module is electrically connected to the electrical system of said electric vehicle.

3. The automatic charging system according to claim 1, wherein said water pipe is configured with a flow controller.
